(19) United States
(12) Patent Application Publication
(10) Pub. No.: US 2023/0186170 A1
(43) Pub. Date: Jun. 15, 2023

(54) CONTENTION DETECTION AND CAUSE DETERMINATION

(71) Applicant: International Business Machines Corporation, Armonk, NY (US)

(72) Inventors: Murtaza Eren Akbiyik, Zürich (CH); Anastasiia Didkovska, Boeblingen (DE); Dorian Czichotzki, Stuttgart (DE); Dieter Wellerdiek, Ammerbuch (DE)

(21) Appl. No.: 17/550,389

(22) Filed: Dec. 14, 2021

(51) Int. Cl. G06N 20/20

(52) U.S. Cl. CPC G06N 20/20

(57) ABSTRACT

A computer-implemented method for identifying a cause of a performance anomaly of a computer system executing workloads in different workload groups is disclosed. The method comprises receiving system performance data, separating contention-related data and non-contention related data within the received system management data, feeding a first part of the contention-related data to a first machine-learning system comprising a trained first machine-learning model for predicting first contention instances and related first impact values as output, and feeding a second part of the contention-related data scaled with the first impact values to a second trained machine-learning system comprising a trained second machine-learning model for predicting second contention instances and related second impact values for the different workload groups as output.

### BACKGROUND

The present invention relates generally to identifying contention cases for throughput in a computer system and, more specifically, to identifying a cause of a performance anomaly of a computer system executing workloads in different workload groups. The present invention relates to a method, computer program product, and system for contention detection and identification of a cause of a performance anomaly of a computer system executing workloads in different workload groups.

Enterprise class computing systems, in contrast to personal computing devices as well as multi-user mid-range computing systems, continue to be complex machines typically operated under the operating system Z/OS™ or IBM Z™ Linux, both originating from IBM to control the operation of computing systems using the known IBM Z™ architecture. In such computing systems, a large plurality of parallel managed virtual machines, partitions, workloads and so on have to be managed (IBM Z and Z/OS are registered trademarks of the International Business Machines corporation, registered in many jurisdictions worldwide). One goal of efficient systems management for such environments, either in an on-premise installation or for a cloud computing environment, is to try to keep the workload level for the enterprise computing system always at a comparably high level. Different jobs executed on such a system may have different dedicated resources assigned, such as CPU, memory, and/or network bandwidth. In general, the workloads are typically managed with a workload management tool which determines how many resources should be given to a specific item of work. This decision process and regulation is typically based on pre-defined goals for prioritized, user-defined workload service classes (SC), generally denoted as groups of workloads. The service definitions (SD) underlying the service classes are normally provided by the system administrator. Thereby, each service class has underlying related goals and priorities that provide essential information for the workload management tool and how to manage the different jobs (i.e., workloads).

### SUMMARY OF THE INVENTION

According to one aspect of the present invention, a computer-implemented method for identifying a cause of a performance anomaly of a computer system executing workloads in different workload groups may be provided. The method may comprise receiving system performance data, separating contention-related data and non-contention related data within the received system management data, and feeding a first part of the contention-related data to a first machine-learning system comprising a trained first machine-learning model for predicting first contention instances and related first impact values as output. Additionally, the method may comprise feeding a second part of the contention-related data scaled with the first impact values to a second trained machine-learning system comprising a trained second machine-learning model for predicting second contention instances and related second impact values for the different workload groups as output.

According to another aspect of the present invention, a contention detection system for identifying a cause of a performance anomaly of a computer system executing workloads in different workload groups may be provided. The contention detection system comprising a processor and a memory, communicatively coupled to the processor, wherein the memory stores program code parts that, when executed, enable the processor, to receive system performance data, to separate contention-related data and non-contention related data within the received system management data, and to feed a first part of the contention-related data to a first machine-learning system comprising a trained first machine-learning model for predicting first contention instances and related first impact values as output.

Furthermore, the process may be enabled when executing the program code to feed a second part of the contention-related data scaled with the first impact values to a second trained machine-learning system comprising a trained second machine-learning model for predicting second contention instances and related second impact values for the different workload groups as output.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

### BRIEF DESCRIPTION OF THE SEVERAL VIEWS OF THE DRAWINGS

It should be noted that embodiments of the invention are described with reference to different subject-matter. In particular, some embodiments are described with reference to method type claims, whereas other embodiments are described with reference to apparatus type claims. However, a person skilled in the art will gather from the above and the following description that, unless otherwise specified, in addition to any combination of features belonging to one type of subject matter, any combination between features relating to different subject matters, in particular, between features of the method type claims and features of the apparatus type claims, is considered as disclosed within this document.

The aspects defined above and further aspects of the present invention are apparent from the examples of embodiments to be described hereinafter and are explained with reference to the examples of embodiments, to which the invention is not limited.

Embodiments of the invention will be described, by way of example, and with reference to the following drawings:

FIG. 1 shows a block diagram of an embodiment of the computer-implemented method for identifying a cause of a performance anomaly of a computer system executing workloads in different workload groups.

FIG. 2 shows a block diagram of an embodiment of a plurality of functional blocks instrumental for executing the method.

FIG. 3 shows a block diagram of a more detailed view of the embodiment of FIG. 2, in particular the system-wise contention analysis using the first machine learning model.

FIG. 4 shows a block diagram of a more detailed view of the embodiment of FIG. 2, in particular the system-wise contention analysis using the second machine-learning model for the workgroup-wise contention analysis.

FIG. 5 shows a block diagram of an embodiment of the inventive contention detection system for identifying a cause of a performance anomaly of a computer system executing workloads in different workload groups.

FIG. 6 shows an embodiment of a computing system comprising the system according to FIG. 5.

### DETAILED DESCRIPTION

In the context of this description, the following conventions, terms and/or expressions may be used:

The term “performance anomaly” denotes an unbalanced workload distribution resulting in performance degradation for workloads of a computing system. The performance anomaly does not have to lead to a system fault for a workload but response times for interactive applications or execution times for batch jobs may be increased.

The term “contention” or system throughput contention, in particular for a computing system, denotes a lower-than average-performance, or lower than anticipated performance of the computing system. More precisely, the terms may be understood to involve concurrent low performance of two or more service classes, (i.e., workload groups) for a period of time. An even more precise definition that could be measured and implemented using deterministic logic would be, “the state of the computing system when two or more service classes are simultaneously performing worse than 3 standard deviations from their average performance for a period of 1 minute.” However, other timeframes may also be chosen. The timeframes may be consecutive time frames or they may be overlapping to form a rolling average. From a broader perspective, without the precise definition given above, it may also be said that in computer system contention situations performance may be impaired and goals not achieved, the root causes of problems may not be easily identified and gut feeling based recommendations are often used to resolve the contention to overcome.

The term “workload” may denote any activity in the form of programs or scripts executed outside a kernel of the operating system of a computing system.

The term “workload group” may denote specific workloads that may be grouped into service classes to which predefined service levels may be applied.

The term “system performance data” as used herein, may denote performance indicator values regularly collected in the computing system, typically by the operating system. In one example, such system performance data may be available in the form of SMF99 data (System Management Facility data record 99).

The term “contention-related data” may denote those system performance data that may comprise either system-wide or workgroup related indicators of the reason or root cause of the contention.

The term “machine-learning system” may denote a computing system (or software in a computing system) comprising a model which has been trained by known data (i.e., input data as well as output data), for the case of a supervised learning process. As a result of the training, the machine-learning system may be enabled to output (i.e., predict) information relating to unknown input without having been trained with the specific unknown input. This is in contrast to procedural programming. Typically, for supervised learning, labeled training data may be required. A machine-learning system using supervised learning would typically have a categorizing, classifying, or regression outcome. In addition to supervised machine learning, systems for unsupervised learning may also be operated. Unsupervised learning techniques are classically used for clustering activities of unknown data. The unsupervised learning model of the system automatically decides how to structure clusters for an amount of unknown data points in an n-dimensional space. Typically, only the number of output clusters may be given as input. Today, a large plurality of different systems, methods and algorithms are available for such tasks.

The term “contention instance” may denote a situation that can be described by the contention-related data in which contention as defined above, occurs in the computing system.

The term “impact value” may denote a value describing the cause or root cause of a contention.

The term “performance metric values for non-contention cases” may denote system performance data that did not relate to any contention.

The term “Gaussians component” may denote one mode of a mixture of Gaussian distributions. Hence, a mixed Gaussian model may comprise a plurality of different modes, (i.e., components).

The term “Tree-structured Parzen Estimator” (TPE) denotes a method that may hinder categorical hypo-parameters in a tree-structured manner. TPE may be used to control optimized hyper-parameters for another machine-learning system or model. This may be a neural network (e.g., a Gradient Boosted Tree, machine-learning system).

For the case of a neural network, the term “hyper-parameter values” may denote parameter values describing, for example, the number of layers, the numbers of node per layer, connections between nodes of different layers, the type of accusation functions of specific nodes, and so on.

The term “Gradient Boosted Tree machine-learning system” (GBT) may denote machine-learning techniques for gradient boosting which may be well suited for regression, classification and/or similar tasks. As such, a prediction model may be generated in the form of an ensemble of weak prediction models, typically, decision trees. If a decision tree is the weak learner model, then the model may be referred to as a gradient boosted tree, which usually outperform random forest algorithms. The model may be built in a stage-wise session, similar to other boosting methods, and the model may generalize stage-wise sessions, allowing optimization of any differentiable loss function. In general, gradient boosting techniques may utilize additive training in which each new tree added to the model may attempt to learn about parts where the previous trained trees failed.

For problems with well-structured (e.g., tabularized) input and limited data (e.g., up to 100k to 1 million data points), boosted trees are considered to be one of the best solutions. Furthermore, the possibility to integrate the SHAP framework (SHapley Additive exPlanations) together with the gradient boosting machine-learning techniques, may allow a fast and accurate analysis of gradient boosting models in order to address the problem of explainability of supervised machine-learning models.

However, because of the very complex and extremely dynamic optimization processing by the workload management tool, bottlenecks in the computing system may result and lead to an unbalanced workload distribution or a performance anomaly. Reasons for such results may include an overload of certain CPU resources, memory shortages, network overloads, a mixture thereof, or other reasons. In short, there may be a workload contention or simply contention in the enterprise class computing system.

In many situations, it is nearly impossible or extremely time-consuming and resource-intensive to analyze the root causes for contention. Therefore, there may be a need for an effective and automatic contention detection system and a related method which may use performance information already available in the system to identify performance anomalies without the need to collect additional data.

Embodiments of the present invention for identifying a cause of a performance anomaly of a computer system executing workloads in different workload groups offers multiple advantages, technical effects, contributions and/or improvements, described as follows.

Embodiments may be instrumental for identifying the most significant factors influencing a performance anomaly of the computing system by pin-pointing the most probable reason for the resource contention, such as a performance bottleneck that prevents a system from achieving its average level of performance. Identifying performance anomaly causing factors will avoid a significant amount of human-based system analysis. Predicting the distribution of workloads across available system resources also enables addressing expected bottlenecks before they occur. Consequently, the existing problem of an absence of a proper mathematical definition of contention and its root cause can be addressed successfully, thereby avoiding biased decisions, improper manual systems management, and performance flaws.

Embodiments are dedicated to labeling performance problems and resource consumption analysis, by using the concept of explainability of the system-initiated service-class resource adoption. Applying embodiments of the present invention enables possible recommendations of potential precaution measures to end-users for current and future contention states and apply these recommendations at the workload management tool level as well, providing both, re-active and proactive contention management. The typical machine-learning approach is non-transparent regarding the recommendation reasons (i.e., prediction). This is also true for system optimization tasks like contention detection. However, in contrast to the traditional approach of machine-learning in the context of systems management and optimization, embodiments disclosed herein also deliver the root causes of potential problems and recommendations based on the determined root causes (i.e., explainability), while achieving and applying machine-learning, thereby providing evidence to the user/operator.

Thus, the major drawback of existing solutions (i.e., the fact that current solutions do not identify a root cause of a performance contention), and the missing opportunity for contention prevention, may be overcome, because embodiments disclosed herein may supply operators and users with relevant information on how to optimize the computing system behavior and mitigate performance contention in the future.

Implementation of embodiments of the present invention may highlight partial performance contention aspects, such as TCP/IP bottlenecks or a shared-memory shortages, but also other types such as memory contention or CPU contention, which may also exist. Embodiments may also apply to the lack of available/shared memory which may affect the CPU performance, cause system lockups, data dumps, or process latency (i.e., wait cycles). By using the multi-staged approach proposed herein, the bottlenecks and causes of the bottlenecks may be clearly identified.

In some embodiments, the limited approaches that may be based on a simple comparison of normal and abnormal system behavior may be overcome. However, the simple comparison approaches may not be considered applicable for enterprise-class mainframe computers due to complex dependencies involving changing workloads, the variety of workloads, the growth of the system utilization, calendar driven impacts (e.g., a workload increase due to an end of the month or quarter), and other interrelated dependencies.

By focusing on workload groups (i.e., service classes), the proposed multi-stage approach provides the analysis results for a performance anomaly to the operator but also provides the results to a workload management tool to complete a feedback loop. The workload management tool makes use of the analysis related data in both a reactive and proactive manner. In some embodiments, service classes and service definitions are automatically adjusted to incorporate the incompatibility and the contention analysis results. In other embodiments, the system and/or the workload management tool predicts future cases of contention and releases resources and bonds, made available to relieve the workload groups that are projected to have an increased demand.

Moreover, by applying the option to iteratively re-train the second machine-learning system by usage over time in a customer environment, the contention detection system together with the workload management tools become tailored specifically to the customer’s requirements and business and workload environment conditions.

In summary, it can be said that in the context of enterprise class computing systems embodiments of the present invention may significantly reduce the manual, time-consuming human effort to detect, analyze, and resolve contention issues. The need for expert knowledge and a considerable amount of time required to detect and analyze system bottlenecks may be measurably reduced. The existing complex problem of incorrect ascertainable measurement attributes for system contention may also be overcome by the proposed technical concept, and all instances of contention can be addressed in order to resolve current and future contentions states through the explainability introduced with the proposed multi-level machine-learning approach. Therefore, reactive and proactive contention management may become possible to diminish the number of contentions.

The following includes description of additional embodiments of the inventive concept applicable for the method, computer program product, and system implementations.

According to one embodiment, the method may also comprise analyzing performance metric values for non-contention cases. In particular, the method may include contention score distribution values from the SMF99 subtype 1 and subtype 2 data, by fitting a number of Gaussians components to the performance metric values for non-contention cases of each of the different workload groups (i.e., the service classes). Embodiments of the present invention split a workload group that includes more than one Gaussian components into two workload groups and enable the forward-looking concept for workload management to be implemented. The different subgroups of the original single workload group may be split according to predefined rules, for example, based on a time when the subgroups have to be activated or based on the resources required for the partial workload groups, and as such, avoiding future contention situations.

One embodiment may comprise feeding a first part of contention-related data during the training phase, such as SMF99 subtype 1 data, as input to a Tree-structured Parzen Estimator algorithm to adapt and/or optimize hyper-parameter values of the first machine-learning model. Adapting/optimizing the hyper-parameter values may prevent an overfitting during the training phase of the first machine-learning model, such as the case in which the first machine-learning model may be based on the known XGBoost library, (i.e., a case in which a Gradient Boosted Tree machine-learning system may be used to implement the first machine-learning system).

As such, in an embodiment, the first machine-learning system may be a Gradient Boosted Tree machine-learning system. The Gradient Boosted Tree ML (machine-learning) system has been shown to deliver superior results towards achieving the goals on which the inventive concept is based, in that it may provide SHAP values as output data which may be used by the second ML model.

Additionally, in some embodiments, the second machine-learning system may also be a Gradient Boosted Tree machine-learning system. However, the use of training data may differ from those of the first ML system, such that system resources may be identifiable that may be responsible for the contention in the computing system. Accordingly, the second ML system addresses the service class contention, whereas the first ML system analyzes the system-wide contention, (i.e., not addressing service classes).

In one embodiment the method feeds the output of the first machine-learning system, the output of the second machine-learning system and performance metric values to a performance visualization system. The visualization system may be, for example, a display system, or, more specifically, a visualization tool which may use the technique of Jupyter Notebook, (i.e., an open-source web application that allows creating, sharing, and visualizing documents in an easy and reliable way).

Another embodiment of the present invention comprises predicting (e.g., by use of the workload management tool), one or more potential future contention cases using a time-series analysis of the second impact values, (i.e., second SHAP values), and data about first contention instances and/or data about second contention instances. The use of the time-series analysis techniques may address future bottlenecks of the computing system and include a feedback loop closure for system optimization.

According to one embodiment of the present invention, the separation of contention-related data and non-contention related data may be performed by determining whether two or more workload groups perform concurrently worse than a predefined number of standard deviations (e.g., three standard deviations with other values possible), run from their average performance value within a predefined period of time. The predefined period of time may be, for example, half a minute, one minute, five minutes, 10 minutes or other predefined time periods. Additionally, the predefined time periods may be overlapping for a determination of a rolling average performance value. In one embodiment, a period of time of one minute may be shown to result in good computing system performance optimization measurements.

In the context of the predefined time periods, and according to another embodiment, two or more workload groups may be determined to refer to a normalized performance index (PI) metric for each of the different workload groups as part of the second part of the contention-related data, (e.g., the SMF99 subtype 2 data). As such, the above-described new contention definition may resolve the sensitivity of the PI by normalizing the metric with its long-term average which empirically converges to a level depending on the goal definition and the workload submitted.

In the following, a detailed description of the figures will be given. All instructions in the figures are schematic. Firstly, a block diagram of an embodiment of the computer-implemented invention for identifying a cause of a performance anomaly of a computer system executing workloads in different workload groups, is given. Additionally, further embodiments will be described that include the contention detection system for identifying a cause of a performance anomaly of a computer system executing workloads in different workload groups.

Before going into a detailed description of the figures, the general concept underlying the embodiments of the present invention should be described in a comprehensive manner.

Embodiments of the present invention are based on three stages: (i) In the first part, a deterministic concept is used to detect system-wide contention based on performance metric values available in the computing system. Additionally, a general definition of contention is used that includes the notions of concurrency, persistency and reduced performance (e.g., “contra performance of two or more service classes for a predefined period of time”).This definition reflects the need for relative performance decrease and competition for limited resources, such as characteristics of contention situations, while also ensuring single findings are correlated by observing the computing system over time.

As a second step, a set of machine-learning models is used to correlate the shortage of different resources (e.g., CPU, I/O, ...), with the detected contention. The correlation enables finding the resources that most likely caused, or did not cause the contention, and how much a specific period of resource shortage contributed to the detected contention.

Subsequent to determining the detection and cause of the computing system contention, embodiments perform an analysis to find the responsible service classes (i.e., workload groups). The results of this step are service classes and the corresponding delay types of resources that contributed most to the contention situation. The delay types can give a more detailed view of the actual source of contention than the resource types obtained at a computing system level.

In addition to performing the service class analysis to detect reliable service classes, a compatibility analysis is also run to determine the classification rules that are inherently flawed.

For the case in which a workload management tool manages jobs together that require exceedingly different resource usage and response time levels, it becomes impossible for the workload manager to distribute the system resources to the service classes in an optimal manner and can therefore lead to contention. In this stage, to remedy the issue the contention levels of service classes are analyzed over time to determine whether the workloads running under one service class presents a diverging behavior. If such a behavior is detected, then the system administrator is notified about the service classes that have an inherent incompatibility, and a recommendation is made to adjust the classification.

The stage of the contention detection can be described as follows: In the contention detection stage, a deterministic, procedural algorithm is executed to classify the data-points into the instances of contention and non-contention, according to the contention definition: “The state of the computing system when two or more Service Classes concurrently perform worse than 3 standard deviations from their average performance, for a minimum time period of 1 minute.”

Or more generally: “concurrent low performance of two or more service classes (i.e., workload groups), over a defined period of time.

The classification makes use of the performance index (PI) metric for each service class which is acquired from system performance records, (e.g., SMF99 subtype 2 records). The PI should be understood as an index calculation of how well work is meeting defined goals. As such values of PI = 1 typically indicates optimal performance, PI < 1 indicates over-performance, and PI > 1 indicates under-performance. PI is used by the workload management tool as the main performance metric on which resource distribution decisions are made. However, calculated PI values are very sensitive to the goal definitions of service classes and the submitted workload.

It should be pointed out that for the embodiments of the present invention, a derivation of PI is used, referred to as “PI Score,” which is defined as:

$$\text{PI Score} = \text{max} \left(0 , \text{PI - 1}\right) .$$

The determination of the deviation from the average performance per each service class makes this definition data-dependent; however, this is both obligatory and beneficial since the service definitions themselves are workload dependent. Furthermore, the newly introduced contention definition resolves the sensitivity of the PI by normalizing the metric with its long-term average which empirically converges to a level depending on the goal definition and the workload submitted.

The result of this inference is then provided to each component of the contention analyzer, as explained in detail below, along with the accompanying resource and performance metrics derived from the relevant performance data, (e.g., subtypes of SMF99).

The second stage (i.e., the contention analysis stage), can be summarized as follows. In the steps described above, the acquired data points are labeled according to the service class PI scores under the provided contention definition; however, the possible causes of these contention states are not separately provided. In the current stage, the analysis is done step-by-step, starting with more abstract system-wide level and then going deeper into the individual service classes.

Firstly, a system-level analysis is performed using the 1^{st} ML system, (e.g., a Gradient Boosted Tree (GBT) model trained with the known XGBoost framework as the main ML component). This has several advantages:
(a) Tree-based ML models, especially ones that belong to the family of Gradient Boosted Trees, are an ideal solution for problems with well-structured (i.e., tabulated) input and limited data (e.g., up to 100k - 1M points), like in the case of SMF.
(b) Tree-based models are much more interpretable if compared to other state-of-the-art models such as neural networks and its derivatives, due to of their rule-based approach that is easy to comprehend and analyze. The particular rule-based feature enabled the development of a game-theoretic framework called SHAP (SHapley Additive exPlanations) which can provide decision explanations for each instance.
(c) The choice of the XGBoost framework offers the advantage of a comprehensive toolkit for training GBT and has built-in support for SHAP.

The model used for the system analysis receives the resource metrics from the first part of the contention-related data (i.e., SMF99 subtype 1) as input, and correlates the metric values with the cases of contention that are inferred from the performance metrics of individual service classes. In order to ensure proper behavior and to prevent over-fitting of the model to the input data, the system analysis model component is pre-trained with a known first part of the contention-related data (e.g., known and labeled SMF datasets), which is dumped from one or more multiple computing systems running under different conditions.

During the pre-training period, the first ML model (e.g., GBT), hyper-parameters are optimized using a Tree-structured Parzen Estimator (TPE). In the case of the first ML model being GBT, the following hyper-parameters are optimized: max_depth, eta, colsample_bytree, gamma, and alpha. A person skilled in the art is familiar with the identified hyper-parameters. For example, the skilled person would recognize “eta” as the rate of learning.

During the analysis the model can initially be fine-tuned with the new input in a process that does not create new trees, but only tunes the split values of each node in order to align the tree prediction with the inferred labels. Subsequently, the input data is used to predict the contention labels, which tend to align with the labels gathered from the performance metrics. This prediction is analyzed to extract the SHAP values for each input-label tuple.

SHAP values which are an interpretation of Shapley values from game theory but applied in a scientific data context, provide the contribution of each feature in a prediction to the final decision of the model. For example, a high positive SHAP value of a co-processor resource utilization in a contention case, such as the zIIP coprocessor for the IBM Z™ architecture (IBM Z is a trademark of the International Business Machines Corp. registered in many jurisdictions worldwide), implies that the contention decision was mostly influenced by the high coprocessor usage. The sum of these contributions accurately provides the expectation of the model output given the input features for a single data point.

The acquired SHAP values for the resource metrics are then fed to a second component of embodiments of the present invention for a service class level analysis.

The service class level analysis can be described as follows. The service class analysis uses the delay metrics for each resource type per service class as input and correlates the delay metric values with the main contention types detected during system-level analysis (as discussed above). The contention types are integer encoded as classification targets, and the numbering is done according to the maximum total contributor to the contention state during the period, which is estimated from the SHAP values provided by the system analysis.

The analysis starts with parsing the necessary delay metrics from the first part of the contention-related data (e.g., the SMF99 Subtype 2 records). The time series data is then fed to a median filter with kernel size of 5, for example, to smooth out the picks in delay values. The input vector for a system utilizes the following structure, where “n” denotes service class (1, 2, ..., n), and “m” denotes a number of chosen delay metrics: | SC1 - delay 1 | SC2 - delay1 |... | SCn - delay1 |... | SCn - delaym |

The varying numbers and configurations of service classes in each service definition prevents the use of a pre-trained model, as the input vector comprises completely different observations/features for data acquired from different computing systems. In order to uncover the relationship between individual delay metrics and the contention cases, a simple Pearson correlation is not sufficient since it is not suitable for binary data and cannot provide a non-linear explanation.

In order to resolve the issue of not using a pre-trained model while still being able to make a non-linear analysis of the data, a very conservative GBT model can be used that can be efficiently trained with a limited number of instances as sets of training data. Several constraints can be applied to the model trained by the XGBoost framework. First, interaction constraints can be used to group each delay type in order to prevent very complex trees with illogical interactions from being built, which ensures that there cannot be non-linear interpretations across delay types, although multiple features can contribute to an output. Secondly, monotone constraints can be applied to each input feature to convey the limitation that increase of a delay cannot contribute to a non-contention decision, and vice versa. This valid limitation proves to be a very tight constraint that allows the GBT to be trained with minimal data without over-fitting.

As a second option, Non-Negative Least Squares (NNLS) that come with built-in monotone constraints can be used in this context instead of GBT. However, as the preferred solution, the XGBoost model can be chosen as it allows feature interactions and further grouping of delay types, both of which are features that cannot be provided with a simple least squares solution.

Another TPE model is used as a hyper-parameter optimizer for the GBT booster. The trained GBT is analyzed with SHAP framework to detect the contributing service classes and delay types. The detected delay types may not always be fully consistent with the main causes uncovered in stage 1 as the more targeted approach provides a deeper insight on the behavior of service classes than the more general system-level analysis.

As a next step, a compatibility analysis is performed. This third stage is detached from the previous two stages and acts as a configuration checker rather than a contention analyzer. Furthermore, the compatibility analysis is built on the proposition: For a given time slot, the total resource consumption of sufficiently numerous jobs in a system with adequate resources tends towards a Gaussian distribution. As long as jobs that are submitted under one service class behave similarly and have a relatively large sample property (n>100 for the purposes of the embodiments described herein), this lemma holds for non-contention samples at which the system has sufficient resources.

Proceeding upon the above proposition, for the non-contention cases, the compatibility analysis checks for the service class performance (i.e., PI score), and whether the service class performance displays a Gaussian distribution or a sum of multiple Gaussians distributions, which in turn means that the service class should be split up according to the behavior of jobs submitted under it.

In order to capture the main Gaussian components of performance distributions, an unsupervised model, referred to as a Dirichlet Process Gaussian Mixture Model (GMM), can be used. In contrast to vanilla GMM, this model enables any number of Gaussian components to be adapted to a distribution. The hyper-parameter “gamma” stands for the sensitivity of the model and is chosen to have a low value for the analysis purposes (1e-6) to enforce a lower number of inferred output components and thus a more conservative model.

Referring to the output analysis and feedback, the output of the last stage, discussed above, can visually be conveyed to a system administrator or operator via dashboard techniques. The analysis results are also fed back to the workload management tool for further usage.

The output usage by the workload management tool can be (i) used as an active service definition adjustment. The service definition may be adjusted by the workload management tool to relieve possible contention cases in the future, by reducing the strictness of the low-importance service class goals that are identified to be in contention with others, as the high importance workload needs to be given a higher priority in the resource distribution. Consequently, the sum of the service classes may be split or reconfigured using the workload management tool according to the results of the compatibility analysis to prevent future bottlenecks.

Additionally, the further usage of the output by the workload management tool can also be (ii) used as a proactive contention resolution. Using the results, the workload management tool may predict possible contention cases in the future making use of a time-series analysis of the contention states. Before predicting periods of contention, the workload management tool may split or reconfigure workloads, possibly requesting or activating more resources, depending on the type of contention predicted, using tools such as System Recovery Boosts. The analyses and the proactive changes will enhance themselves over time by way of the proposed feedback loop.

Based on this more general overview some embodiments of the technical solution shall be described.

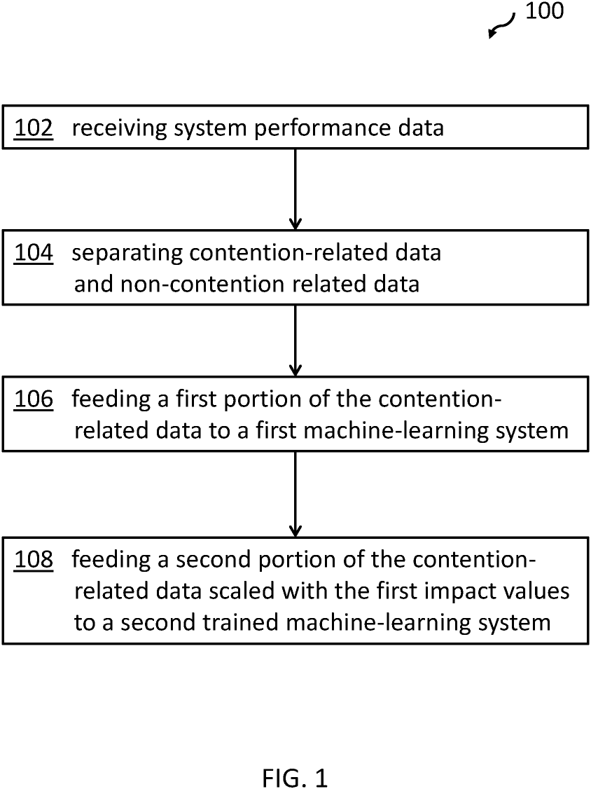

FIG. 1 shows a block diagram of a method 100 of an embodiment of the present invention for identifying one or more causes of a performance anomaly, such as a performance bottleneck or contention, of a computer system, which typically includes complex mainframe systems executing workloads in different workload groups, often referred to as service classes. The method comprises receiving (step102), system performance data. For example, one or more records comprising performance data for a time-point can be derived from SMF99 subtype 1 & 2 records for a case in which the computing system is an IBM Z™ architecture computer system operating on a Z/OS™ operating system (IBM Z and Z/OS are registered trademarks of the International Business Machines corporation, registered in many jurisdictions worldwide), and using a tool such as a system management facility.

The method 100 also comprises separating (step 104), contention-related data and non-contention related data within the received system management data, and feeding (step106), a first part of the contention-related data (e.g. SMF99 subtype1) to a first machine-learning system, for example, GBT, comprising a trained first machine-learning model for predicting (i.e., classifying or labeling) first contention instances, including whether a contention happened or not, and related first impact values as output. The output may be the previously mentioned Shapley Additive exPlanations (SHAP) values. The result includes delivery of the system level analysis.

Furthermore, the method 100 comprises feeding (step 108), a second set of the contention-related data scaled with the first impact values to a second trained machine-learning system, which may also be a GBT system (e.g., for IBM Z™ architecture computers, SMF99 subtype 2 data that include delay metric values for each resource, per service class). The second set of contention-related data could also be non-linearly scaled according to a predefined formula. The second trained machine-learning system includes a model for predicting second contention labels, such as whether a contention situation exists and related second impact values for the different workload groups, as output. Also, the output includes SHAP values that may be used to indicate the root cause of the contention.

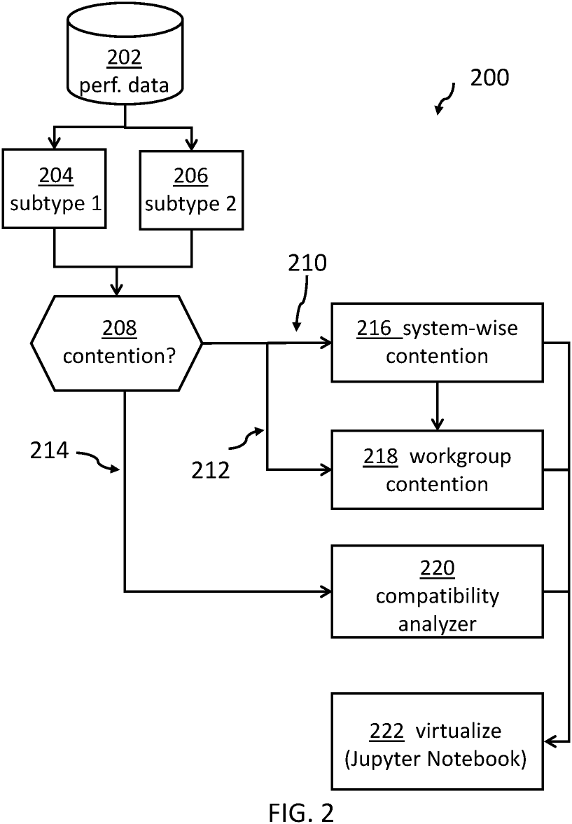

FIG. 2 shows a block diagram of a process flow 200 for executing an embodiment of the present invention in a form of an architecture model. The process flow starts (block 202), by providing performance data, such as contention-related data that may include, for example, a form of SMF record 99 data. The data are separated in two steps into system metric data, (e.g., SMF subtype 1 data 204), and workgroup metric data, (e.g., SMF subtype 2 data 206). In some embodiments, the separation of data can be performed by a deterministic decision model. Furthermore, the subtype 2 data can include information about the service classes included in the workgroup.

In decision step 208 embodiments of the present invention perform a separation between contention-related data (subtype 1 data, pathway 210, and subtype 2 data, pathway 212), and contention scores for non-contention samples (pathway 214). The first part of the contention-related data (i.e., subtype 1 data) is fed to the first machine learning system (block 216), also denoted as a system-wise contention analyzer using a trained Gradient Boosted Tree (GBT) machine-learning system, for example. The analysis produces SHAP value results, which may be used for labeling of the contention-related data. SMF type 99, subtype 1 records contain system level data, the traces of system resource management actions, and data about resource groups. SMF type 99, subtype 2 records contain data for service classes. A subtype 2 record is written every policy interval for each service class if any period in the service class had recent activity.

In parallel, embodiments feed a second part of the contention-related data (e.g., the subtype 2 data), to the second machine-learning system (block 218), which may also be denoted as a workgroup contention analyzer also using a trained Gradient Boosted Tree machine-learning system. As second input for this second machine-learning system, the output of the first machine-learning system is also used. Embodiments output service classes that relate to the system contention as output from the second machine-learning system.

Also performed in parallel, embodiments of the present invention feed the contention scores for non-contention samples (block 214), to a compatibility analyzer (block 220), which may be implemented in the form of a Dirichlet Process Gaussian Mixture Model (GMM). Embodiments use the GMM to discover sub-populations or clusters within a set of data, such as the service classes determined as the root cause for the system contention. In some embodiments, the fact is used that the Gaussian mixture model has parameters that correspond to a probability that a specific data point belongs to a specific sub-population. In such cases, the probability function is a Gaussian distribution, (i.e., the traditional bell-shaped curve with a mean and standard deviation) and can be used for single or multiple variable models. The Dirichlet Process Gaussian Mixture Model fits an arbitrary number of Gaussian components to a given distribution. If the fit clearly provides more than one Gaussian components, then the defined service class might be split into two service classes, so that the workload management tool can manage the computing system more easily and without contention.

As a final step in FIG. 2, it is indicated that the respective output data of the first machine-learning model for system-wise contention (block 216), the second machine-learning system for analyzing workgroup-related contention (block 218), and the compatibility analyzer 220 can be visualized (block 222), to an operator, for example, by means of the known Jupyter Notebook techniques or other visualization approaches.

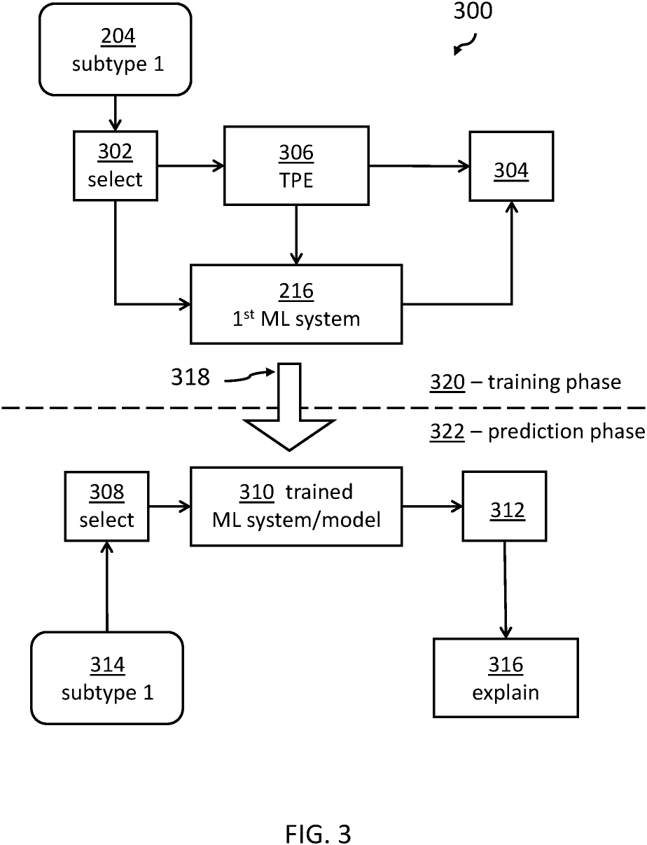

FIG. 3 shows a block diagram of detailed view 300 of the embodiment of FIG. 2, in particular the system-wise contention analysis using the first machine learning model. Detailed view 300 of FIG. 3 includes a split into an upper part, training phase 320, and a lower part dedicated to the prediction phase 322, or operational phase of the first machine-learning model. As already described above, embodiments of the present invention select the contention-related data (e.g., subtype 1 data 204, select block 302), and embodiments feed the selected data as training data to the 1^{st} machine-learning system, block 216 under training conditions. In order to avoid an over-fitting of the 1^{st} ML system, block 216, the training data are also fed to the Tree-structured Parzen Estimator (TPE block 306), in order to fine-tune the hyper-parameters of the first ML system, block 216, which include the values defining the architecture of the first ML system. Block 304 indicates the output data of this machine-learning stage.

If the underlying machine-learning model of the first machine learning system, block 216, has been trained, for example at a manufacturing site, the model can be transferred, as symbolized in FIG. 3 by arrow 318, to an active production environment, for example, a customer site. However, the training may also be performed in its entirety by using customer data instead of a more general and larger set of training data from multiple customers.

In the production environment of a customer, the system-wide contention data 314 are gathered and used as a data source and embodiments select data (block 308). Embodiments feed the selected data to the trained machine-learning system/model (block 310) and the system/model generates as output (block 312), the data already described in the context of FIG. 2. Embodiments forward the output to the explainer (block 316), indicating the root cause of the system-wide contention.

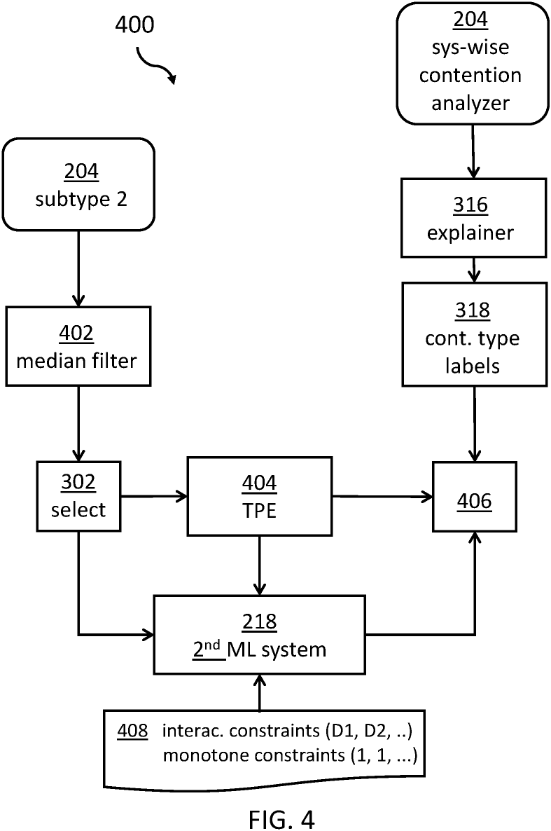

FIG. 4 shows a block diagram of detailed view 400 of the embodiment of FIG. 2, in particular the system-wise contention analysis using the second machine-learning model, such as for the work-group-wise contention analysis. As already indicated (cf. FIG. 2), embodiments of the present invention receive the workgroup related part of the contention-related data, (e.g., SMF subtype 2 data 204), as input. Embodiments feed the workgroup part of the contention-related data to a media filter, block 402 used to normalize the data and reduce data noise. The available features can then be used in the structured form of: |SC1 - delay1 |SC2 - delay1 | .. |SCn - delay1 |.. | SCn - delaym | the filtered data is selected, block 302, and fed as input data to the 2^{nd} machine-learning system, 218 for a work-group-wise analysis. The hyper-parameters of the 2^{nd} machine-learning system, block 218 can also be optimized by feeding selected data through a parallel TPE system 404. Furthermore, as a first point, the interaction constraints {D1, D2, ...} (reference number 408) are used to group each delay type, in order to prevent very complex trees with illogical interactions from being built. As a second point, monotone constraints {1, 1, ...} (also included in reference number 418) are applied to each input feature to convey the limitation that an increase of a delay cannot contribute to a non-contention decision, and vice versa.

The output 406 is then used together with the output of the first machine learning system, i.e., the system-wise contention analyzer 310 (FIG. 3), the explainer 316 (i.e., the SHAP values) and the system-wide contention type labels 318.

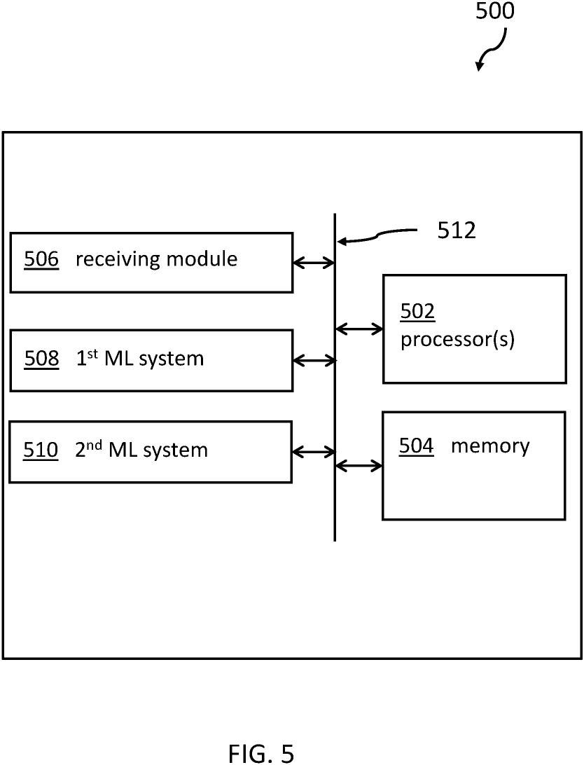

FIG. 5 shows a block diagram of an embodiment of the present invention including contention detection system 500 for identifying a cause of a performance anomaly of a computer system executing workloads in different workload groups. The contention detection system 500 comprises a processor 502 and a memory 504, communicatively coupled to the processor 502, wherein the memory 504 stores program code parts that, when executed, enable the processor 502 to receive system performance data, using a receiving module 506, to separate contention-related data and non-contention related data within the received system management data, in particular by a deterministic separation unit, and to feed a first portion of the contention-related data to a first machine-learning system 508 (cf. block 216, FIG. 2), comprising a trained first machine-learning model for predicting first contention instances and related first impact values as output.

Furthermore, while executing the program code, the processor can also be caused to feed a second portion of the contention-related data scaled with the first impact values to a second trained machine-learning system 510 (cf. block 218, FIG. 2), comprising a trained second machine-learning model for predicting second contention instances and related second impact values for the different workload groups as output.

It shall also be mentioned that all functional units, modules and functional blocks (i.e., processor 502, memory 504, 1^{st} ML model 506, and 2^{nd} ML model 508), may be communicatively coupled to each other for signal or message exchange in a selected 1:1 manner. Alternatively, the functional units, modules and functional blocks can be linked to a system internal bus 512 for a selective signal or message exchange.

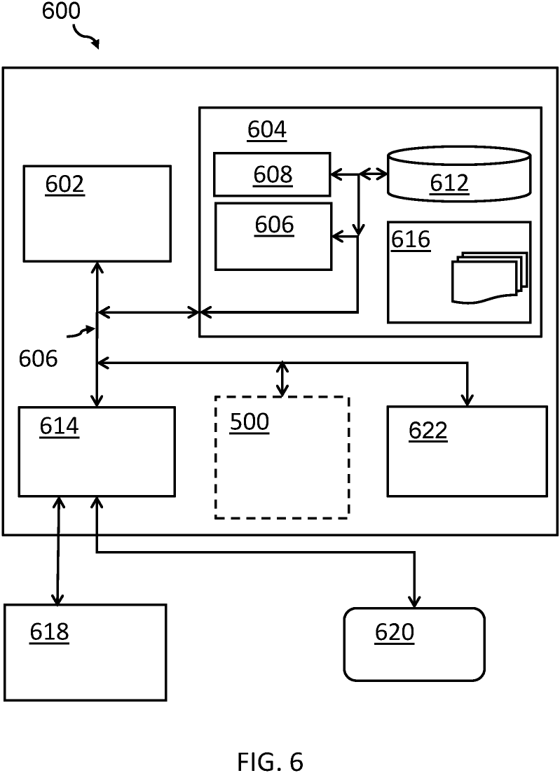

Embodiments of the present invention may be implemented together with virtually any type of computer, regardless of the platform being suitable for storing and/or executing program code. FIG. 6 shows, as an example, a computing system 600 suitable for executing program code similar to embodiments of the present invention.

Computing system 600 is only one example of a suitable computer system and is not intended to suggest any limitation as to the scope of use or functionality of embodiments of the present invention described herein, regardless, whether computing system 600 is capable of being implemented and/or performing any of the functionality set forth hereinabove. In computer system 600, there are components, which are operational with numerous other general purposes or special purpose computing system environments or configurations. Examples of well-known computing systems, environments, and/or configurations that may be suitable for use with computing system 600 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computing system 600 may be described in the general context of computer system-executable instructions, such as program modules, being executed by computing system 600. Generally, program modules may include routines, programs, objects, components, logic, data structures, and so on that perform particular tasks or implement particular abstract data types. Computing system 600 may be practiced in distributed cloud computing environments where tasks are performed by remote processing devices that are linked through a communications network. In a distributed cloud computing environment, program modules may be located in both, local and remote computer system storage media, including memory storage devices.

As shown in FIG. 6, computing system 600 is shown in the form of a general-purpose computing device. The components of computing system 600 may include, but are not limited to, one or more processors or processing units 602, a system memory 604, and a bus 606 that couple various system components including system memory 604 to the processor 602. Bus 606 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computing system 600 typically includes a variety of computer system readable media. Such media may be any available media that is accessible by computing system 600, and it includes both, volatile and non-volatile media, removable and non-removable media.

The system memory 604 may include computer system readable media in the form of volatile memory, such as random access memory (RAM) 608 and/or cache memory 610. Computing system 600 may further include other removable/non-removable, volatile/non-volatile computer system storage media. By way of example only, a storage system 612 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 606 by one or more data media interfaces. As will be further depicted and described below, memory 604 may include at least one program product having a set (e.g., at least one) of program modules that are configured to carry out the functions of embodiments of the present invention.

The program/utility, having a set (at least one) of program modules 616, may be stored in memory 604 by way of example, and not limiting. Additionally, memory 604 may also include an operating system, one or more application programs, other program modules, and program data. Each of the operating systems, one or more application programs, other program modules, and program data or some combination thereof, may include an implementation of a networking environment. Program modules 616 generally carry out the functions and/or methodologies of embodiments of the invention, as described herein.

The computing system 600 may also communicate with one or more external devices 618 such as a keyboard, a pointing device, a display 620, etc.; one or more devices that enable a user to interact with computer system/server 600; and/or any devices (e.g., network card, modem, etc.) that enable computing system 600 to communicate with one or more other computing devices. Such communication can occur via Input/Output (I/O) interfaces 614. Still yet, computing system 600 may communicate with one or more networks such as a local area network (LAN), a general wide area network (WAN), and/or a public network (e.g., the Internet) via network adapter 622. As depicted, network adapter 622 may communicate with the other components of the computing system 600 via bus 606. It should be understood that other hardware and/or software components, although not shown, could be used in conjunction with computing system 600. Examples, include, but are not limited to, microcode, device drivers, redundant processing units, external disk drive arrays, RAID systems, tape drives, and data archival storage systems, etc.

Additionally, the contention detection system 500 for identifying a cause of a performance anomaly of a computer system executing workloads in different workload groups may be attached to the bus system 606.

The descriptions of the various embodiments of the present invention have been presented for purposes of illustration but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be based on electronic, magnetic, optical, electromagnetic, infrared or a semi - conductor technologies. Examples of a computer-readable medium include a semiconductor or solid-state memory, magnetic tape, a removable computer diskette, a random access memory (RAM), a read - only memory (ROM), a rigid magnetic disk and an optical disk. Current examples of optical disks include compact disk - read only memory (CD-ROM), compact disk-read / write (CD R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non - exhaustive list of more specific examples of the computer readable storage medium includes the following : a portable computer diskette, a hard disk, a random access memory (RAM), a read - only memory (ROM), an erasable programmable read - only memory (EPROM or Flash memory), a static random access memory (SRAM), a portable compact disk read - only memory (CD - ROM), a digital versatile disk (DVD), a memory stick, a floppy disk, a mechanically encoded device such as punch - cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber - optic cable), or electrical signals transmitted through a wire.

Computer readable program instructions described herein can be downloaded to respective computing / processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing / processing device receives computer readable program instructions from the network and forwards the computer readable program instructions for storage in a computer readable storage medium within the respective computing / processing device.

Computer readable program instructions for carrying out operations of the present invention may be assembler instructions, instruction-set-architecture (ISA) instructions, machine instructions, machine dependent instructions, microcode, firmware instructions, state -setting data, or either source code or object code written in any combination of one or more programming languages, including an object-oriented programming language such as Smalltalk, C++ or the like, and conventional procedural programming languages, such as the C programming language or similar programming languages. The computer readable program instructions may execute entirely on the user’s computer, partly on the user’s computer as a stand - alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions / acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function / act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions / acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware - based systems that perform the specified functions or act or carry out combinations of special purpose hardware and computer instructions.

The terminology used herein is for the purpose of describing particular embodiments only and is not intended to limit the invention. As used herein, the singular forms a, an, and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for identifying a cause of a performance anomaly of a computer system executing workloads in different workload groups, the method comprising:
receiving, by one or more processors, system performance data;
separating, by the one or more processors, contention-related data and non-contention related data within the received system management data;
feeding, by the one or more processors, a first part of the contention-related data to a first machine-learning system comprising a trained first machine-learning model, wherein the first machine-learning model provides a prediction of first contention instances and related first impact values as output; and
feeding, by the one or more processors, a second part of the contention-related data scaled with the first impact values to a second trained machine-learning system comprising a trained second machine-learning model for predicting second contention instances and related second impact values for the different workload groups as output.

2. The method according to claim 1, further comprising:
analyzing, by the one or more processors, performance metric values for non-contention cases by fitting a number of Gaussian components to the performance metric values for non-contention cases of each of the different workload groups; and
in response to determining a workload group comprising more than one Gaussian components, splitting, by the one or more processors, the workload group into two workload groups.

3. The method according to claim 1, further comprising:
feeding, by the one or more processors, a first part of contention-related training data as input to a Tree-structured Parzen Estimator to adapt hyper-parameter values of the first machine-learning model.

4. The method according to claim 1, wherein the first machine-learning system is a Gradient Boosted Tree machine-learning system.

5. The method according to claim 1, wherein the second machine-learning system is a Gradient Boosted Tree machine-learning system.

6. The method according to claim 1, further comprising:
feeding, by the one or more processors, the output of the first machine-learning system, the output of the second machine-learning system and performance metric values to a performance visualization system.

7. The method according to claim 1, further comprising:
predicting, by the one or more processors, a possible contention case using a time-series analysis of the second impact values and first contention instances and/or second contention instances.

8. The method according to claim 1, wherein the separating contention-related data and non-contention related data further comprises:
determining, by the one or more processors, that two or more workload groups perform concurrently worse than a predefined number of standard deviations from their average performance within a predefined period of time.

9. The method according to claim 8, wherein the predefined period of time is at a minimum one minute.

10. The method according to claim 8, wherein determining that two or more workload groups perform concurrently worse than a predefined number of standard deviations from their average performance within the predefined period of time, further comprises:
referring, by the one or more processors, to a normalized performance index metric for each of the different workload groups as part of the second part of the contention-related data.

11. A computer system for contention detection and cause identification of a performance anomaly of a computer system executing workloads including different workload groups, the system comprising:
one or more processors;
one or more computer-readable storage media, and program instructions stored on the one or more computer-readable storage media, wherein program instructions, when executed, enable the one or more processors to:
receive system performance data;
separate contention-related data and non-contention related data within the received system management data;
feed a first part of the contention-related data to a first machine-learning system comprising a trained first machine-learning model for predicting first contention instances and related first impact values as output; and
feed a second part of the contention-related data scaled with the first impact values to a second trained machine-learning system comprising a trained second machine-learning model for predicting second contention instances and related second impact values for the different workload groups as output.

12. The computer system of claim 11, wherein the one or more processors are further enabled when executing the program instructions to:
analyze performance metric values for non-contention cases by fitting a number of Gaussian components to the performance metric values for non-contention cases of each of the different workload groups; and
in response to determining a workload group comprising more than one Gaussian components, split the workload group into two workload groups.

13. The computer system of claim 11, wherein the one or more processors are further enabled when executing the program instructions to:
feed a first part of contention-related training data as input to a Tree-structured Parzen Estimator to adapt hyper-parameter values of the first machine-learning model.

14. The computer system of claim 11, wherein the first machine-learning system is a Gradient Boosted Tree machine-learning system.

15. The computer system of claim 11, wherein the second machine-learning system is a Gradient Boosted Tree machine-learning system.

16. The computer system of claim 11, wherein the one or more processors are further enabled when executing the program instructions to:
feed the output of the first machine-learning system, the output of the second machine-learning system, and performance metric values to a performance visualization system.

17. The computer system of claim 11, wherein the one or more processors are further enabled when executing the program instructions to:
predict a possible contention case using a time-series analysis of the second impact values and first contention instances and/or second contention instances.

18. The computer system of claim 11, wherein the separating contention-related data and non-contention related data further comprises:
determining that two or more workload groups perform concurrently worse than a predefined number of standard deviations from their average performance within a predefined period of time.

19. The computer system of claim 18, wherein the determining that two or more workload groups perform concurrently worse than a predefined number of standard deviations from their average performance within a predefined period of time, further comprises:
referring to a normalized performance index metric for each of the different workload groups as part of the second part of the contention-related data.

20. A computer program product for identifying a cause of a performance anomaly of a computer system executing workloads in different workload groups, the computer program product comprising:
a computer readable storage medium having program instructions embodied therewith, the program instructions, when executed, cause the program instructions to:
receive system performance data;
separate contention-related data and non-contention related data within the received system management data;
feed a first part of the contention-related data to a first machine-learning system comprising a trained first machine-learning model for predicting first contention instances and related first impact values as output; and
feed a second part of the contention-related data scaled with the first impact values to a second trained machine-learning system comprising a trained second machine-learning model for predicting second contention instances and related second impact values for the different workload groups as output.
